(19) United States
(12) Patent Application Publication
(10) Pub. No.: US 2026/0132883 A1
(43) Pub. Date: May 14, 2026

(54) MONITOR STAND

(71) Applicant: TILTA INC., Burbank, CA (US)

(72) Inventors: Sen WU, Shenzhen (CN); Weihan SHE, Shenzhen (CN); Wenping ZENG, Shenzhen (CN); Kefeng ZHOU, Shenzhen (CN)

(21) Appl. No.: 19/379,499

(22) Filed: Nov. 4, 2025

(30) Foreign Application Priority Data
Nov. 8, 2024 (CN) 202422736909.5

(51) Int. Cl. F16M 11/12; F16M 11/20; F16M 13/02

(52) U.S. Cl. CPC F16M 11/125; F16M 11/2014; F16M 13/022; F16M 2200/022

(57) ABSTRACT

A monitor stand includes a connecting base, a support arm, a monitor mounting base, and a locking assembly. The connecting base is configured for fixing the monitor stand to an installation foundation. The support arm is connected to the connecting base. The monitor mounting base is rotatably connected to an end of the support arm, which is away from the connecting base, around a first rotation axis. Either the support arm or the monitor mounting base incorporates an inner race, while the other features an outer race. The inner and outer races are rotatably connected around the first rotation axis. The inner race is equipped with a transmission surface, whereas the outer race has an abutment surface that cooperates with the locking assembly. The locking assembly can press against the abutment surface to lock the inner and outer races, thereby preventing the monitor mounting base from rotating downward.

### CORSS-REFERENCE TO RELATED APPLICATIONS

The present application for patent claims priority to and the benefit of pending Chinese Application No. 2024227369095, filed November 08, 2024, and hereby expressly incorporated by reference herein as if fully set forth below in its entirety and for all applicable purposes.

### TECHNICAL FIELD

The present disclosure pertains to the technical field of display facilities, specifically to a monitor stand.

### INTRODUCTION

Monitors are extensively utilized in the filming industry to display camera shooting effects. With the widespread adoption of monitors, the use of monitor stands has also become prevalent. A monitor stand can be installed on various foundations, such as cameras or workbenches, enabling users to position the monitor in the desired workspace. However, existing monitor stands, while capable of fixing the monitor, often suffer from instability during use due to the constant load imposed by the monitor's weight. This issue makes it challenging to meet practical usage requirements and causes inconvenience to users.

### BRIEF SUMMARY

Aspects of the present disclosure provide a monitor stand configured to improve the stability of monitor support, thereby overcoming the instability issues prevalent in current monitor stands.

Some aspects of the present disclosure provide: a connecting base, configured for fixation to an installation foundation; a support arm, connected to the connecting base; a monitor mounting base, rotatably connected around a first rotation axis to the end of the support arm, which is away from the connecting base, for mounting a monitor; and a locking assembly.

Wherein, either the support arm or the monitor mounting base incorporates an inner race, while the other features an outer race. The inner and outer races are rotatably connected around the first rotation axis. The inner race has a transmission surface, whereas the outer race has an abutment surface that cooperates with the locking assembly. Positioned adjustably between the abutment surface and the transmission surface along the radial direction of the inner race, the locking assembly can press against the abutment surface to lock the inner and outer races, thereby preventing the monitor mounting base from rotating downward.

According to the aforementioned embodiment, by connecting the connecting base and the monitor mounting base via the support arm, the monitor mounting base can move relative to the connecting base, facilitating the adjustment of the monitor mounting base's position during use; by connecting the mounting piece and the monitor mounting base via the support arm, the monitor mounting base can move relative to the mounting piece, facilitating the adjustment of the monitor mounting base's position during use. Through the cooperation of the locking assembly, the outer race, and the inner race, the locking assembly can press against the abutment surface to lock the inner and outer races, preventing the monitor mounting base from rotating downward. In essence, the locking assembly, positioned along the radial direction of the inner race between the abutment surface and the transmission surface, enables auxiliary locking to fix the relative position between the support arm and the monitor mounting base. This effectively prevents the entire monitor mounting base from rotating downward relative to the support arm due to the monitor's self-weight, maintaining the monitor's position and enhancing the stability of the monitor mount during operation.

### BRIEF DESCRIPTION OF THE DRAWINGS

FIG. 1 is a schematic diagram illustrating a monitor stand with a locking assembly in a first position according to some aspects of the disclosure.

FIG. 2 is a side view of the monitor stand of FIG. 1 according to some aspects of the disclosure.

FIG. 3 is a schematic cross-sectional view taken along line A-A in FIG. 2 according to some aspects of the disclosure.

FIG. 4 is a front view of the monitor stand of FIG. 1 according to some aspects of the disclosure.

FIG. 5 is a schematic cross-sectional view taken along line B-B in FIG. 4 according to some aspects of the disclosure.

FIG. 6 is a side view of the monitor stand of FIG. 1 with the locking assembly in the second position according to some aspects of the disclosure .

FIG. 7 is a schematic cross-sectional view taken along line C-C in FIG. 6 according to some aspects of the disclosure.

FIG. 8 is an exploded diagram illustrating a monitor mounting base and a connecting head in the monitor stand of FIG. 1 according to some aspects of the disclosure.

FIG. 9 is a perspective view of FIG. 8 according to some aspects of the disclosure.

FIG. 10 is a diagram illustrating a retainer in FIG. 8 according to some aspects of the disclosure.

FIG. 11 is a schematic overall view of the monitor stand with the locking assembly in the first position according to some aspects of the disclosure.

FIG. 12 is an exploded view of the monitor mounting base and the connecting head in the monitor stand of FIG. 11 according to some aspects of the disclosure.

FIG. 13 is a diagram of the retainer in the monitor stand of FIG. 11 according to some aspects of the disclosure.

FIG. 14 is a diagram of a first exemplary connecting base according to some aspects of the disclosure.

FIG. 15 is a diagram of a second exemplary connecting base according to some aspects of the disclosure.

FIG. 16 is a schematic diagram of the monitor mounting base, locking assembly, and connecting head of the monitor stand, shown in the first position, according to additional aspects of the disclosure.

FIG. 17 is an exploded view of FIG. 16 according to some aspects of the disclosure.

FIG. 18 is another exploded view of FIG. 17 according to some aspects of the disclosure.

FIG. 19 is another perspective view of FIG. 18 according to some aspects of the disclosure.

FIG. 20 is a cross-sectional view of FIG. 16 according to some aspects of the disclosure.

FIG. 21 is a cross-sectional view of the monitor mounting base, locking assembly, and connecting head of FIG. 16 corresponding to a state of the second position according to some aspects of the disclosure.

Reference Numerals: 100-connecting base; 110-fixed section; 120-movable section; 130-clamping lever; 140-clamping cavity; 150-through-hole mounting desk clamp; 160-edge-clamp mounting desk clamp;

200-support arm; 210-outer race; 211-abutment surface; 212-working surface; 213-wedge-shaped space; 214-accommodation groove; 220-connecting head; 221-first connecting body; 222-second connecting body; 223-spring arrangement groove; 224-waist-shaped clamping groove; 230-main arm; 240-rotary connecting shaft; 250-first shaft sleeve; 260-expansion sleeve; 261-expansion end; 262-fixed end; 263-annular boss; 264-inclined surface; 270-adjustment column; 271-conical surface; 280-second shaft sleeve;

300-monitor mounting base; 310-inner race; 311-transmission surface; 320-mounting base body; 330-connecting body;

400-locking assembly; 410-transmission member; 420-elastic member; 430-retainer; 431-actuation part; 432-protrusion; 433-mounting groove; 434-first chamber; 435-second chamber; 436-annular limiting protrusion; 440-elastic sheet; 450-first elastic element; 460-latch pin.

### DETAILED DESCRIPTION

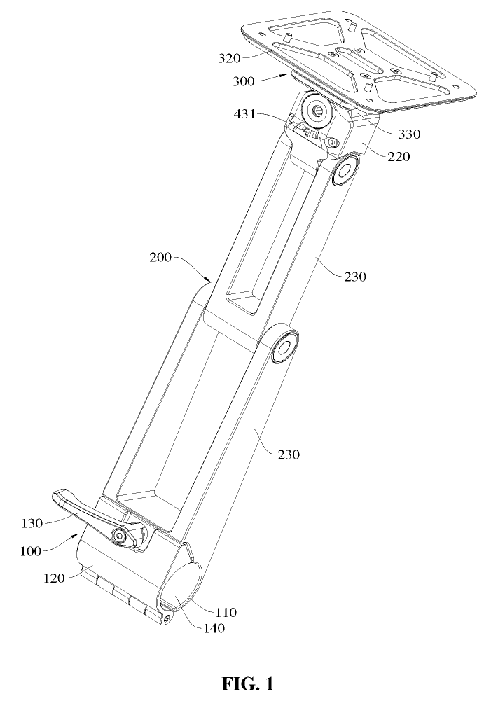

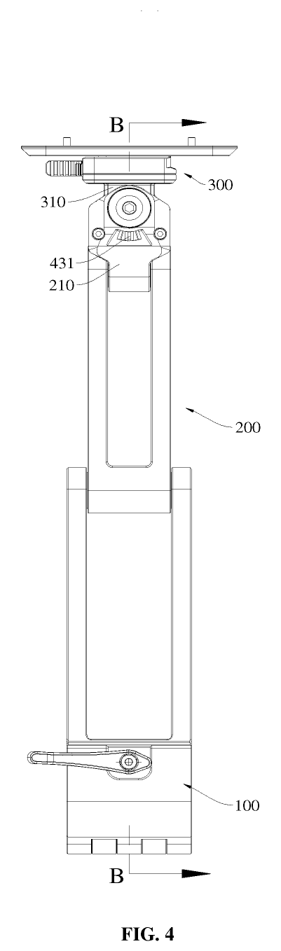

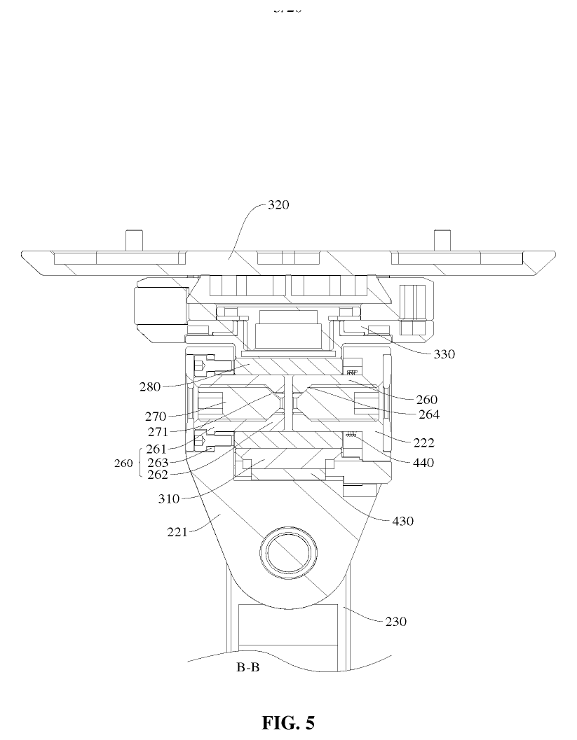

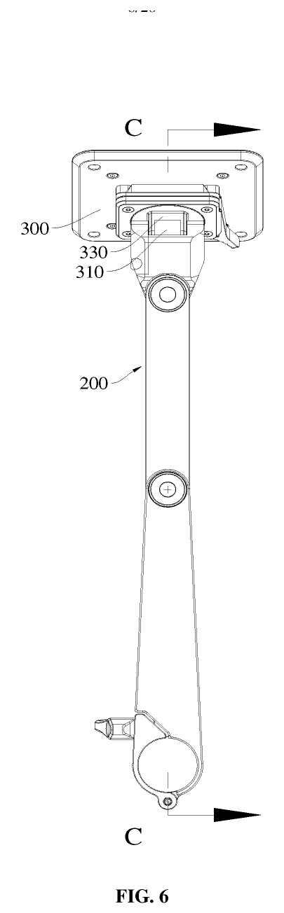

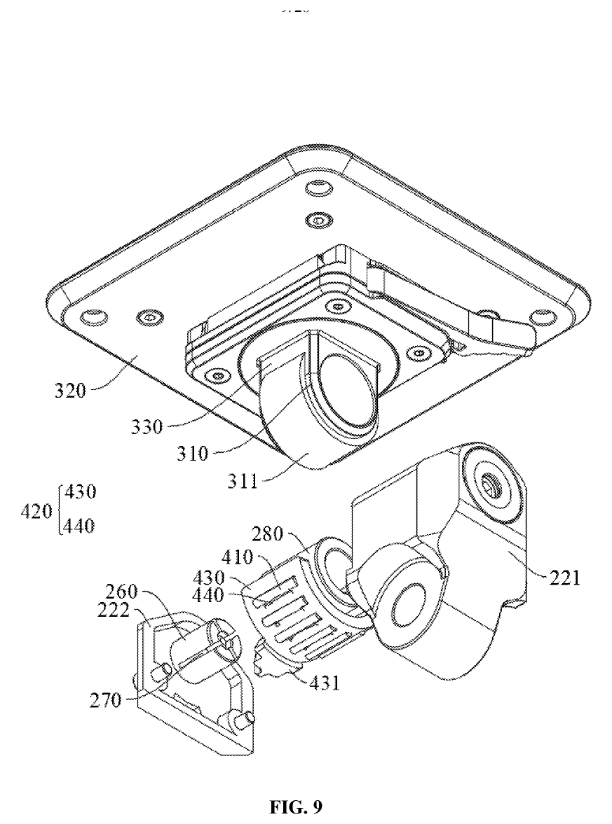

Aspects of the present disclosure introduce a monitor stand that can address the technical challenge of instability in monitor fixation with existing monitor stands due to the constant load of the monitor's weight. Referring to FIGS. 1-13, the monitor stand includes a connecting base 100, a support arm 200, a monitor mounting base 300, and a locking assembly 400. The connecting base 100 is configured for fixation to an installation foundation. The support arm 200 is connected to the connecting base 100. The monitor mounting base 300 is rotatably connected around a first rotation axis to one end of the support arm 200, which is away from the connecting base 100, for mounting a monitor. By connecting the connecting base 100 and the monitor mounting base 300 via the support arm 200, the monitor mounting base 300 can move relative to the connecting base 100, facilitating the adjustment of the monitor's position. After adjusting the relative position and angle between the monitor mounting base 300 and the support arm 200 to the desired angle, the locking assembly 400 is utilized to lock the monitor mounting base 300 and the support arm 200 when the monitor mounting base 300 has a tendency to rotate downward relative to the support arm 200, thereby preventing the entire monitor mounting base 300 from undergoing downward rotational displacement relative to the support arm 200. Consequently, after loading the monitor, the monitor mounting base 300 can effectively bear the monitor's weight, and the locking assembly 400 can effectively prevent the monitor mounting base 300 from being driven by the monitor to rotate downward relative to the support arm 200 during use, thereby enhancing the stability of the monitor stand.

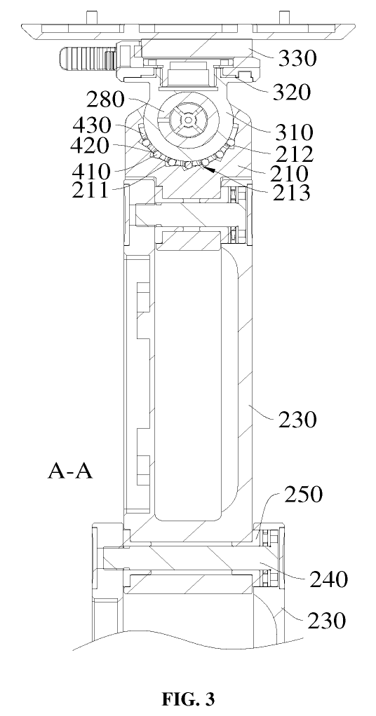

Referring to FIGS. 3 and 7-13, either the support arm 200 or the monitor mounting base 300 can incorporate an inner race 310, while the other features an outer race 210. The inner race 310 and the outer race 210 are rotatably connected around a first rotation axis. The inner race 310 has a transmission surface 311, whereas the outer race 210 has an abutment surface 211 that cooperates with the locking assembly 400. Positioned along the radial direction of the inner race 310, the locking assembly 400 is arranged adjustably between the abutment surface 211 and the transmission surface 311. The transmission surface 311 is utilized to transfer the rotational force or the force from the rotational tendency to the locking assembly 400. When the monitor mounting base 300 has a tendency to rotate downward relative to the support arm 200, the locking assembly 400 can press against the abutment surface 211 to lock the inner race 310 and the outer race 210 together, thereby preventing the monitor mounting base 300 from rotating downward.

In the aforementioned monitor stand, by connecting the connecting base 100 and the monitor mounting base 300 via the support arm 200, the monitor mounting base 300 can move relative to the connecting base 100 , facilitating the adjustment of the monitor mounting base 300's position during use. Through the cooperation of the locking assembly 400, the outer race 210, and the inner race 310, the locking assembly 400 can press against the abutment surface 211 to lock the inner race 310 and the outer race 210, preventing the monitor mounting base 300 from rotating downward. In essence, the locking assembly 400, positioned along the radial direction of the inner race 310 between the abutment surface 211 and the transmission surface 311, enables auxiliary locking to fix the relative position between the support arm 200 and the monitor mounting base 300. This effectively prevents the entire monitor mounting base 300 from rotating downward relative to the support arm 200 due to the monitor's self-weight, maintaining the monitor's position and enhancing the stability of the monitor mount during operation.

In some aspects, referring to FIGS. 3 and 7-13, the locking assembly 400 includes a transmission member 410 and an elastic member 420 that can be connected or abut against each other. Both the transmission member 410 and the elastic member 420 can be situated between the abutment surface 211 and the transmission surface 311. The elastic member 420 is configured to provide an elastic force to the transmission member 410. When the monitor mounting base 300 is subjected to a downward force, the transmission surface 311 triggers the transmission member 410 to abut tightly against the abutment surface 211, thereby locking the inner race 310 and the outer race 210. In other words, the elastic member applies a biasing force to the transmission member 410, urging it into pressing against the abutment surface 211. When the monitor mounting base 300 has a tendency to rotate downward relative to the support arm 200, the transmission member 410, under the action of the transmission surface 311 and the elastic member 420, locks the inner race 310 and the outer race 210. When the monitor mounting base 300 has a tendency to rotate upward relative to the support arm 200, the transmission member 410 overcomes the force of the elastic member 420, allowing it to disengage from tightly pressing against the abutment surface 211.

In some aspects, referring to FIGS. 3 and 7-13, the locking assembly 400 further includes a retainer 430. The retainer 430 is positioned between the abutment surface 211 and the transmission surface 311. The retainer 430 is rotationally engaged with the inner race 310 and is adjustably rotatable relative to the inner race 310 and the outer race 210. That is, in the absence of an external force, the relative position between the retainer 430 and the outer race 210 remains substantially fixed. The transmission member 410 is installed on the retainer 430. When the position of the retainer 430 changes, the position of the transmission member 410 also changes accordingly. The retainer 430 has an actuation part 431 exposed outside the support arm 200 and/or the monitor mounting base 300. The actuation part 431 enables a user to manually adjust the position of the retainer 430, causing a change in the relative position between the transmission member 410 and the abutment surface 211, thereby enabling the locking assembly 400 to switch between a first position and a second position. When the retainer 430 is in the first position, the monitor mounting base 300 is rotatable upward relative to the support arm 200, and when the monitor mounting base 300 is subjected to a downward force, the inner race 310 can drive the transmission member 410 to abut tightly against the abutment surface 211, thereby locking the inner race 310 and the outer race 210. When the retainer 430 is in the second position, the locking assembly 400 unlocks the inner race 310 and the outer race 210, allowing the monitor mounting base 300 to rotate both downward and upward around the first rotation axis relative to the support arm 200.

During use, after the locking assembly 400 is adjusted and switched to the first position, considering only the locking assembly 400 and the abutment surface 211, the elastic member 420 pre-presses the transmission member 410 against the abutment surface 211. Without external force, the monitor mounting base 300 tends to rotate downward relative to the support arm 200 under its own weight. At this juncture, the abutment surface 211 and the transmission surface 311 exhibit a tendency for relative rotation. The transmission surface 311 exerts a certain oblique force on the transmission member 410. The direction of this oblique force is substantially aligned with the direction in which the elastic member 420 presses the transmission member 410 against the abutment surface 211, thereby further pressing the transmission member 410 against the abutment surface 211. Consequently, the transmission member 410, the transmission surface 311, and the abutment surface 211 cannot undergo relative movement, achieving the effect of locking the inner race 310 and the outer race 210.

In the aforementioned monitor stand, the inner race 310 transmits its rotational force or the force from its rotational tendency to the transmission member 410 via the transmission surface 311, causing the transmission member 410 to receive an oblique force and tend to move or rotate. Driven by the transmission surface 311, if a tightly pressed contact state is established between the transmission member 410 and the abutment surface 211, then the inner race 310 and the outer race 210 cannot rotate relative to each other. If there is sufficient clearance between the transmission member 410 and the abutment surface 211, meaning they do not contact or the force between them is insufficient to achieve a locked and pressed state, then the inner race 310 and the outer race 210 can rotate relative to each other. Some aspects of the present disclosure configure the inner race 310, the outer race 210, and the locking assembly 400 in such a way that: when the locking assembly 400 is in the first position and the monitor mounting base 300 tends to rotate downward relative to the support arm 200, the transmission member 410 is driven by the transmission surface 311 to press tightly against the abutment surface 211, achieving locking. The direction in which the monitor mounting base 300 tends to rotate downward relative to the support arm 200 aligns with the direction of the gravitational force acting on the monitor. Consequently, this allows the vertical height position of the monitor mounting base 300 to be locked both in the ready-to-use state without a monitor installed and in the use state with a monitor installed.

That is to say, when the locking assembly 400 is in the first position and the monitor mounting base 300 tends to rotate downward relative to the support arm 200, the cooperation of the locking assembly 400, the inner race 310, and the outer race 210 enables locking between the abutment surface 211 and the transmission surface 311, thereby preventing the monitor mounting base 300 from rotating downward relative to the support arm 200. This does not affect angle adjustment between the monitor mounting base 300 and the support arm 200 under other conditions. In some aspects, when the locking assembly 400 is in the first position, the monitor mounting base 300 can rotate upward relative to the support arm 200; and when the locking assembly 400 is in the second position, the monitor mounting base 300 can rotate bidirectionally about the first rotation axis relative to the support arm 200 for angle adjustment. After the angle is adjusted and the locking assembly 400 is switched to the first position, it effectively prevents the entire monitor mounting base 300 from rotating downward relative to the support arm 200 due to the weight of the monitor, thereby keeping the monitor's position fixed and effectively enhancing the stability of the monitor mount during use.

For ease of understanding, in some aspects of the disclosed monitor stand, when the locking assembly 400 is in the first position, the operating principle of the rotational cooperation mechanism formed among the locking assembly 400, the support arm 200, and the monitor mounting base 300 is similar to that of a one-way bearing, which may serve as a conceptual reference for understanding the mechanism. When the locking assembly is adjusted to the second position, the cooperation among the locking assembly 400, the support arm 200, and the monitor mounting base 300 is disengaged, so that the locking assembly does not hinder the relative movement between the support arm 200 and the monitor mounting base 300. At this time, the monitor mounting base 300 can freely rotate about the first rotation axis relative to the support arm 200, allowing for angle adjustment in both clockwise and counterclockwise directions, i.e., it can rotate upward and downward, enhancing the convenience of the monitor stand and allowing users to quickly adjust the monitor mounting base 300 to the desired angle and position. In some embodiments, the monitor mounting base 300 can even be designed as a detachable split structure, thereby achieving angle adjustment within a 360° range.

In other words, in the first position state, the design resembles the one-way rotation of a one-way bearing. At this time, the monitor mounting base 300 can be rotated upward relative to the support arm 200 to raise its height position. After upward adjustment of the monitor mounting base 300 is completed and the external force is removed, the locking assembly 400 locks the inner race 310 and the outer race 210, thereby preventing the monitor mounting base 300 from rotating downward relative to the support arm 200. In the second position, the transmission member 410 and the abutment surface 211 remain in an unlocked state, allowing bidirectional adjustment of the monitor mounting base 300. At this time, the monitor mounting base 300 can freely rotate both upward and downward within an adjustable angle range relative to the support arm 200.

It should be noted that this disclosure does not specifically limit the scheme for achieving "the locking assembly 400 being adjustably disposed between the abutment surface 211 and the transmission surface 311, and the locking assembly 400 being switchable and adjustable between the first position and the second position". It can be achieved by adaptively designing the structure and profile distribution of the abutment surface 211, so that the distance between the locking assembly 400 and the abutment surface 211 differs when the locking assembly 400 is in the first position versus the second position. For example, in some embodiments, it can be a scheme achieved by adjusting the position of the inner race 310 or the outer race 210 relative to the locking assembly 400. In other embodiments, it can also be a scheme achieved by adjusting the position of the locking assembly 400 relative to the abutment surface 211.

In some aspects, the retainer 430 and the elastic member 420 can be separate components. The elastic member 420 can be a spring, an elastic washer, or an elastic sheet, etc., and the disclosure of which is not limited in this context.

This disclosure does not limit the installation position of the elastic member 420. For example, in some embodiments, one end of the elastic member 420 can be connected to the transmission member 410, and the other end can be connected to the abutment surface 211. In some aspects, the elastic member 420 can be disposed on the retainer 430. The retainer 430 has a mounting groove 433. The transmission member 410 is movably arranged within the mounting groove 433. The elastic member 420 is fixed to the retainer 430 and extends into the mounting groove 433 to abut against or connect to the transmission member 410. In the absence of external force, the elastic member 420 holds the transmission member 410 in place within the mounting groove 433. When the locking assembly 400 is in the first position and the monitor mounting base 300 tends to rotate upward relative to the support arm 200, the transmission surface 311 can drive the transmission member 410 to compress the elastic member 420, thereby changing the position of the transmission member 410 within the mounting groove 433. This allows the locking assembly 400 to be pre-assembled as a single unit, which can then be directly connected and assembled with the inner race 310 and the outer race 210, simplifying the assembly process.

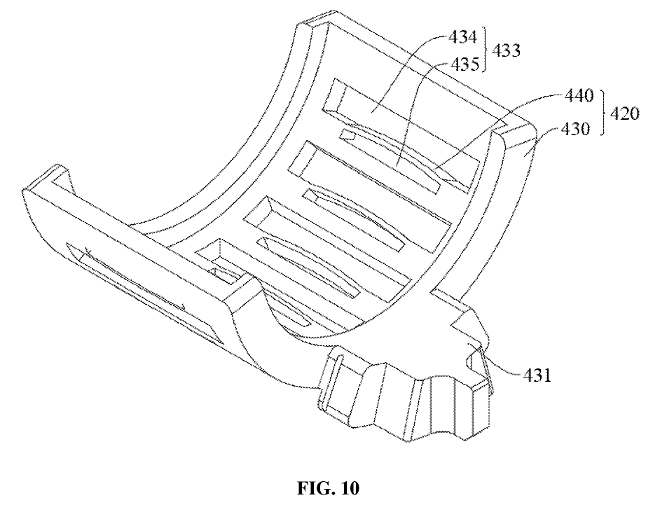

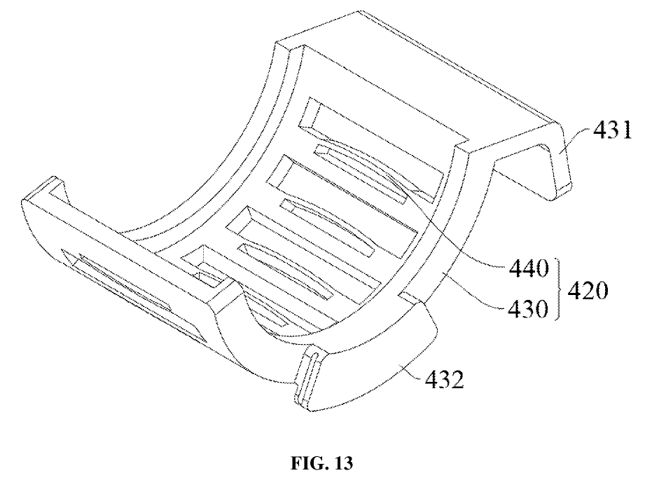

In some aspects, referring to FIGS. 10 and 13, both the mounting grooves 433 and the transmission members 410 are multiple in number and equal in quantity. The elastic member includes elastic sheets 440 equal in number to the mounting grooves 433. The elastic sheets 440 are integrally formed with the retainer 430, and the elastic sheets 440 and the retainer 430 together constitute the elastic member 420. The elastic sheets 440 are fixed within the mounting grooves 433. Each mounting groove 433 includes a first chamber 434 and a second chamber 435. An elastic sheet 440 partitions the first chamber 434 and the second chamber 435, and the elastic sheet 440 bulges towards the first chamber 434 to abut against the transmission member 410. The transmission members 410 are fixed respectively within the first chambers 434 via the corresponding elastic sheets 440. When the retainer 430 is in the first position and the monitor mounting base 300 tends to rotate upward relative to the support arm 200, the transmission surface 311 can drive the transmission member 410 to abut against the elastic sheet 440, causing the transmission member 410 to disengage from tightly abutting against the abutment surface 211, thereby allowing the monitor mounting base to rotate upward relative to the support arm; thus unlocking the inner race 310 and the outer race 210. When the retainer 430 moves to the second position, the retainer 430 can cause the transmission member 410 to move, unlocking the inner race 310 and the outer race 210, and allowing the monitor mounting base 300 to rotate both downward and upward about the first rotation axis relative to the support arm 200.

On one hand, the elastic sheets 440 are integrally formed with the retainer 430, collectively constituting the elastic member 420, which eliminates the assembly and connection steps between the elastic sheets 440 and the retainer 430. Simultaneously, the transmission members 410 are installed and fixed within the first chambers 434 by pre-compressing the elastic sheets 440. The second chamber 435 reserves space for the compression of the elastic sheet 440. When the monitor mounting base 300 tends to rotate upward relative to the support arm 200, the elastic sheets 440, as the primary deformation parts of the elastic member 420, bear the moment transmitted by the transmission member 410. The transmission surface 311 can drive the transmission member 410 to overcome the elastic force of the elastic sheet 440, causing the transmission member 410 to no longer press tightly against the abutment surface 211, significantly reducing the resistance between the transmission member 410 and the abutment surface 211. This resistance can even drop to zero at some moments or remain zero consistently, meaning the contact between the transmission member 410 and the abutment surface 211 might be nominal, non-existent at times, or consistently non-existent. On the other hand, multiple mounting grooves 433, multiple transmission members 410, and multiple elastic sheets 440 correspond one-to-one, achieving installation and force transmission cooperation. This effectively increases the interaction force among the inner race 310, the locking assembly 400, and the outer race 210 when the monitor mounting base 300 tends to rotate downward relative to the support arm 200 under usage conditions, thereby effectively enhancing the stability of the locking between the inner race 310 and the outer race 210.

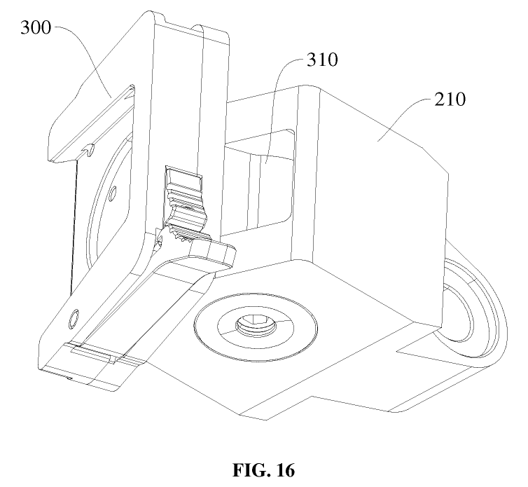

As an alternative embodiment, referring to FIGS. 16 – 21, the retainer 430 is equipped with mounting grooves 433, and the transmission members 410 are positioned within these mounting grooves 433. One end of the elastic member 420 is connected to either the outer race 210 or the retainer 430, with the other end connected to the transmission member 410. Unlike the previously described embodiment where the elastic sheets 440 are integrated with the retainer 430 to form the elastic member 420, in this embodiment, the elastic member 420 and the retainer 430 are separate components. The elastic member 420 is designed so that when the retainer is in the first position and the monitor mounting base 300 tends to rotate downward relative to the support arm 200, it works in conjunction with the inner race 310 to enable the transmission member 410 to press firmly against the abutment surface 211. This effectively reduces the manufacturing and forming difficulties of the various components of the monitor stand while locking the inner race 310 and the outer race 210.

In some aspects, referring to FIGS. 16 – 21, there are multiple mounting grooves 433 and transmission members 410, arranged in a one-to-one correspondence. The elastic member 420 includes multiple springs. Each end of each transmission member 410 is connected to a spring, and the end of the spring opposite the transmission member 410 is connected to either the outer race 210 or the retainer 430. This arrangement ensures that each transmission member 410 in the locking assembly 400 can operate steadily, effectively enhancing the stability of the monitor stand when carrying a monitor.

In some aspects, referring to FIGS. 16 – 21, the elastic member 420 can be a bent component, with its two bent ends forming spring parts respectively. The outer periphery of the outer race 210 is correspondingly provided with positioning protrusions for connecting and positioning the spring parts. One spring part extends into the mounting groove 433 and abuts between the transmission member 410 and the wall of the mounting groove 433. The other spring part is fitted over a positioning protrusion to be stably fixed to both the retainer 430 and the outer race 210.

In some aspects, referring to FIGS. 16 – 21, both sides of the retainer 430 are provided with annular limiting protrusions 436 along the circumferential direction of the inner race 310. The outer race 210 is situated between the two annular limiting protrusions 436, and both sides of the outer race 210 are equipped with multiple accommodation grooves 214. Each spring is placed in a corresponding accommodation groove 214. The relative position between the outer race 210 and the retainer 430 is determined by the two annular limiting protrusions 436, ensuring that the transmission member 410 always aligns with the position of the abutment surface 211 when the retainer 430 switches between the first and second positions.

This disclosure does not restrict the structures of the abutment surface 211 and the transmission member 410, as long as the function of one-way locking in the first position and bidirectional rotation in the second position can be achieved. For instance, in other embodiments, along the radial direction of the inner race 310, the transmission surface 311 and the abutment surface 211 can be concentrically arranged, and the distance between corresponding parts of the transmission surface 311 and the abutment surface 211 is uniform, meaning the abutment surface 211 is can be an arc surface. In this case, locking and unlocking are achieved through the rotation of the transmission member 410, which can be understood by referring to the principle of a sprag-type one-way bearing. That is, the transmission member 410 can be a cam sprag block with two different engagement dimensions. The first engagement dimension is smaller than the gap between the transmission surface 311 and the abutment surface 211, allowing relative rotation between the transmission surface 311 and the abutment surface 211. The second engagement dimension is larger than the gap between the transmission surface 311 and the abutment surface 211, so that under the action of the arc-shaped transmission member 410, the transmission member 410 can abut tightly against the abutment surface 211, locking the inner race 310 and the outer race 210. In the absence of external force, the transmission surface 311 and the elastic member cause the transmission member 410 to self-adjust its rotation, automatically switching between the two engagement dimensions. To enable the switching of the locking assembly 400 between the first and second positions in this scenario, the cam-sprag-shaped transmission member 410 can be configured to be adjustable and fixable via the actuation part 431 to the angle corresponding to the first engagement dimension (corresponding to the situation in the second position), preventing the transmission member 410 from pressing tightly against the abutment surface 211, thereby achieving free bidirectional rotation in the second position.

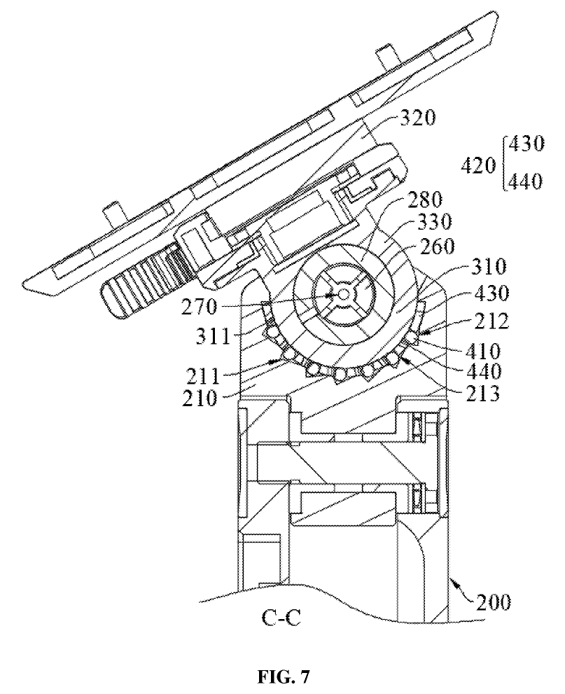

In some aspects, referring to FIGS. 7, 8, and 20, the abutment surface 211 can include multiple working surfaces 212, each corresponding one-to-one with the positions of the multiple transmission members 410. Along the circumference of the outer race, all the multiple working surfaces 212 are inclined, creating multiple wedge-shaped spaces 213 on the abutment surface. When the locking assembly 400 is in the first position, the transmission member 410 is located at the narrow end of the wedge-shaped space 213 and presses against the working surface. When the locking assembly 400 switches from the first position to the second position, the transmission member 410 moves towards the wide end of the wedge-shaped space 213, unlocking the abutment surface 211 and the transmission surface 311. In the first position, when the monitor mounting base 300 tends to rotate downward relative to the support arm 200, the transmission surface 311 pulls the transmission member 410 towards the narrow end of the wedge-shaped space 213. The transmission member 410 enters an engaged state, tightly wedging the inner race 310 and the outer race 210 together and transmitting torque. When the monitor mounting base 300 tends to rotate upward relative to the support arm 200, under the action of the transmission surface 311, the oblique force on the transmission member 410 does not press it towards the abutment surface 211, allowing the transmission member 410 to rotate and disengage the locking between the inner race 310 and the outer race 210. In this case, the transmission member 410 can only rotate, or it can be driven by the inner race 310 towards the wide end of the wedge-shaped space 213. In summary, this causes the transmission member 410 to automatically disengage from the abutment surface 211. The inner race 310 and the outer race 210 are in a released state and do not transmit torque, serving only for rotational cooperation.

Those skilled in the art, upon understanding the solution of the present disclosure, should be able to comprehend how the working surfaces 212 need to be inclined in monitor stands with different structural layouts across various embodiments to achieve the technical effect: "when the retainer 430 is in the first position and the transmission member 410 is at the narrow end of the wedge-shaped space 213, the monitor mounting base 300 can rotate upward relative to the support arm 200, and when the monitor mounting base 300 is subjected to a downward force, the inner race 310 can drive the transmission member 410 to press against the working surface 212, thereby locking the inner race 310 and the outer race 210.”

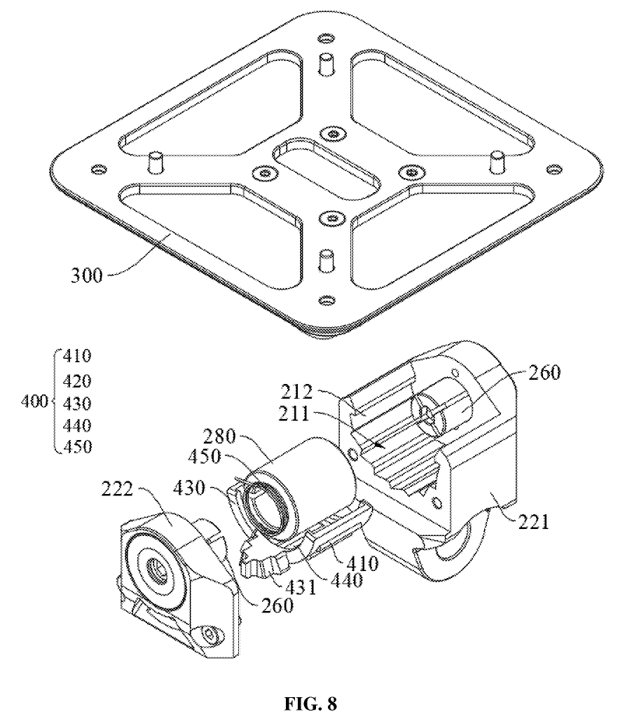

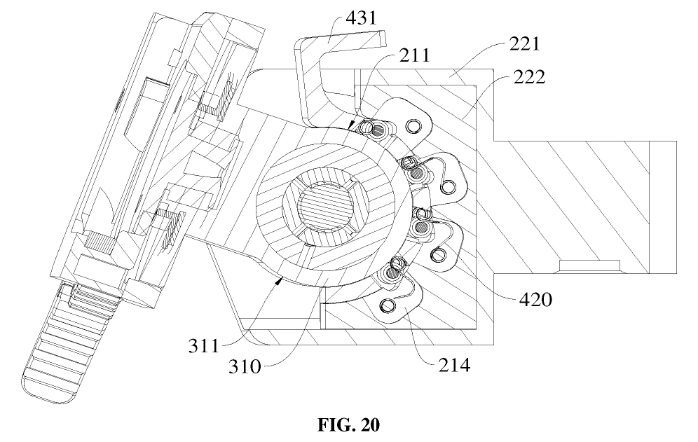

For example, referring to FIGS. 8 and 20, the inner race 310 is mounted on the monitor mounting base 300, and the outer race 210 is mounted on the support arm 200. The abutment surface 211 includes multiple working surfaces 212, each corresponding one-to-one with the positions of the multiple transmission members. Along the direction of the monitor mounting base 300 rotating downward relative to the support arm 200, one end of each of the multiple working surfaces 212 is inclined along the circumferential direction of the outer race 210 towards the direction of the monitor mounting base's downward rotation, thus forming the wedge-shaped spaces 213. When the locking assembly 400 switches from the first position to the second position, the transmission member 410 moves towards the wide end of the wedge-shaped space 213 to unlock the abutment surface 211 and the transmission surface 311.

In some aspects, when the inner race 310 is mounted on the support arm 200 and the outer race 210 is mounted on the monitor mounting base 300, the abutment surface 211 includes multiple working surfaces 212, each corresponding one-to-one with the positions of the multiple transmission members 410. Along the direction of the monitor mounting base 300 rotating downward relative to the support arm 200, one end of each of the multiple working surfaces 212 is inclined along the circumferential direction of the outer race 210 towards the direction of the monitor mounting base's upward rotation, so as to be able to abut tightly against the transmission member 410, while the other end forms a wedge-shaped space 213. When the locking assembly 400 switches from the first position to the second position, the transmission member 410 moves towards the wide end of the wedge-shaped space 213 to unlock the abutment surface 211 and the transmission surface 311.

In some aspects, referring to FIGS. 7 – 9, there are multiple transmission members 410, which can be rollers. These multiple rollers are arranged at intervals along the circumferential direction of the inner race 310, corresponding one-to-one with the multiple working surfaces 212. On one hand, the rollers cooperate with both the abutment surface 211 and the transmission surface 311 through line contact, which can increase the contact area between them. On the other hand, the multiple transmission members 410 can increase the interaction force with the abutment surface 211, significantly enhancing the stability when locking the inner race 310 and the outer race 210.

In some aspects, to ensure that the locking assembly 400 remains stably in the first position without external force, thereby preventing the height position of the monitor mounting base 300 from changing during use, referring to FIGS. 1 - 7 and 11, the locking assembly 400 further includes a first elastic element 450. One end of the first elastic element 450 is connected to or abuts against the retainer 430, and the other end is connected to or abuts against the outer race 210. The first elastic element 450 is designed to return the retainer 430 from the second position to the first position in the absence of external force, thereby further enhancing the stability of the monitor stand and allowing the monitor to be stably fixed at the required height and angle.

In some aspects, referring to FIGS. 1 – 7, the support 200 includes a connecting head 220 and a main arm 230 that are rotatably connected. The connecting head 220 is connected to the monitor mounting base 300. The connecting head 220 has either the abutment surface 211 or the transmission surface 311. The main arm 230 is connected to the connecting base 100.

In some aspects, the number of main arms 230 can be at least two. When the support arm 200 includes at least two main arms 230, each main arm 230 is movably connected in sequence. Increasing the number of main arms 230 can expand the range of motion and degrees of freedom of the monitor mounting base 300, further enhancing the adjustability of the monitor stand. For example, the support arm 200 includes two main arms 230 that are rotatably connected to each other. The connecting base 100 and the monitor mounting base 300 are respectively located at the opposite ends of the two main arms 230.

In other examples, the quantity of main arms 230 can be set to one, three, four, or other numbers as desired. The rotation axes between the main arms 230 can be parallel, perpendicular, or staggered, and can be selected flexibly according to actual needs.

In some aspects, referring to FIG. 3, one of the two main arms 230 that are rotatably connected is equipped with a rotary connecting shaft 240, and the other is provided with a shaft hole. The rotary connecting shaft 240 passes through the shaft hole, enabling the two main arms 230 to be rotatably connected. A first shaft sleeve 250 is mounted on the rotary connecting shaft 240. At least a portion of the first shaft sleeve 250 is retained between the two main arms 230 to provide a damping effect, making the rotation between the two main arms 230 damped.

In some aspects, referring to FIG. 3, the connecting head 220 is rotatably connected to the other end of one main arm 230. Similarly, any feasible damping cooperation scheme can provide a damping effect for the relative rotation between the connecting head 220 and the main arm 230, helping the connecting head 220 to be fixed relative to the main arm 230 at a required angle.

In some aspects, referring to FIGS. 1-3, the rotational connection structure between the main arms 230 can be the same as the rotational connection structure between the main arm 230 and the connecting head 220 described above, facilitating the adjustment of the rotational damping degree at each rotational connection point in the same manner during use. In some aspects, different rotational connection structures can also be employed between the main arms 230.

In some aspects, referring to FIGS. 3-9, the monitor mounting base 300 includes the inner race 310. The connecting head 220 constitutes the outer race 210. The connecting head 220 includes a first connecting body 221 and a second connecting body 222 that are connected together. Both the first connecting body 221 and the second connecting body 222 are rotatably connected to the inner race 310 about the first rotation axis. The abutment surface 211 is provided on the first connecting body 221. The retainer 430 is installed on the first connecting body 221 and the second connecting body 222, and the actuation part 431 is exposed outside the first connecting body 221 or the second connecting body 222.

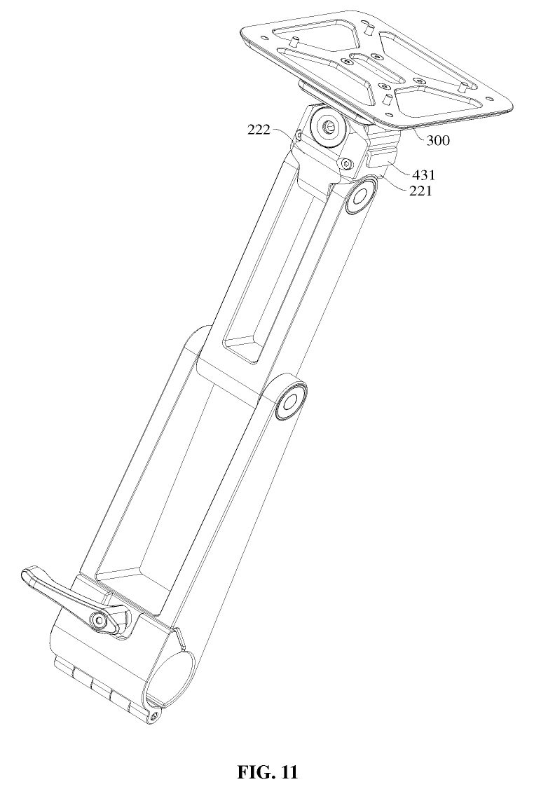

In some aspects, referring to FIGS. 1-11, the actuation method for the actuation part 431 can be a toggling method. In other embodiments, referring to FIGS. 11-13, the actuation method for the actuation part 431 can be a pressing method.

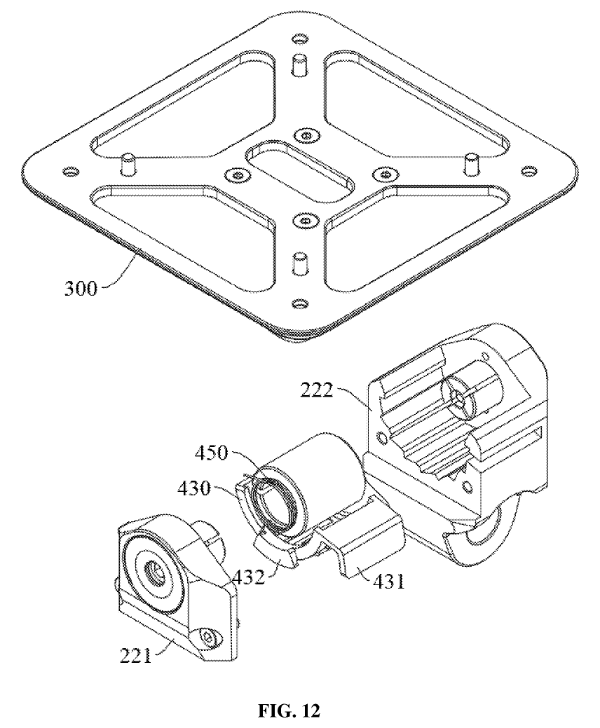

In some aspects, referring to FIG. 8, the first elastic element 450 can be a torsion spring, one end of the torsion spring abuts against the actuation part 431, and the other end abuts against the connecting head 220. In other embodiments, referring to FIG. 12, the first elastic element 450 can be a torsion spring. The retainer 430 is further provided with a protrusion 432. One end of the torsion spring abuts against the protrusion 432, and the other end abuts against the connecting head 220.

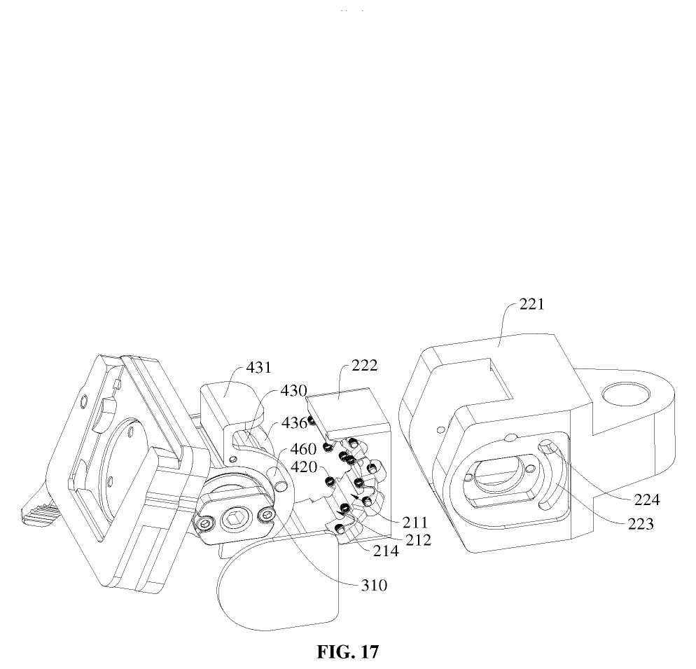

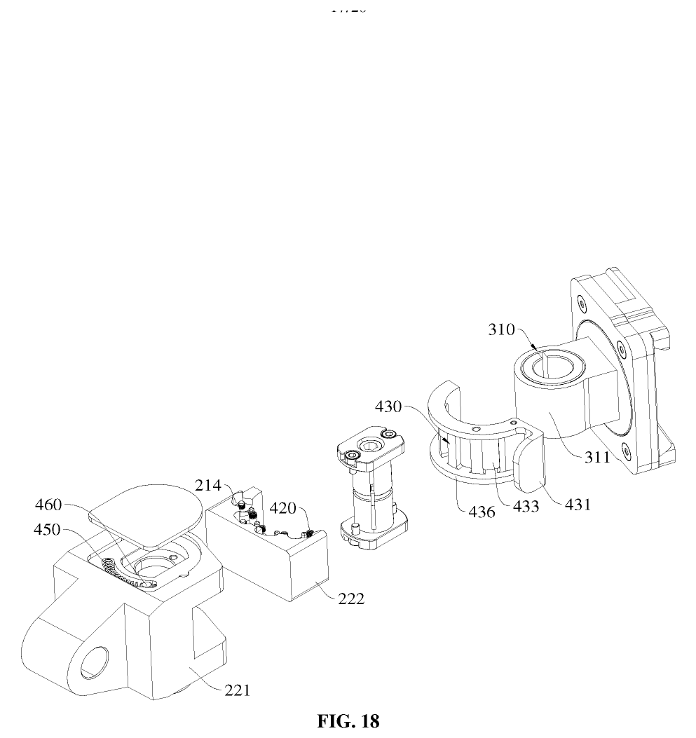

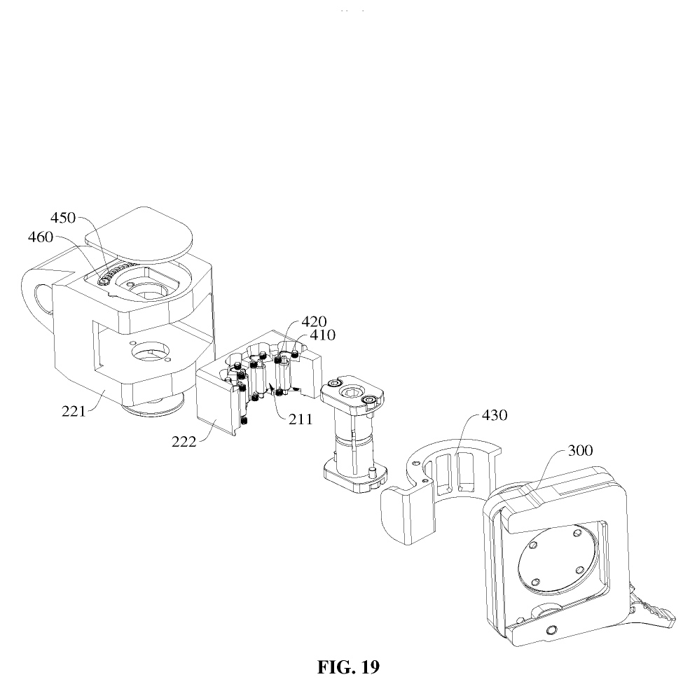

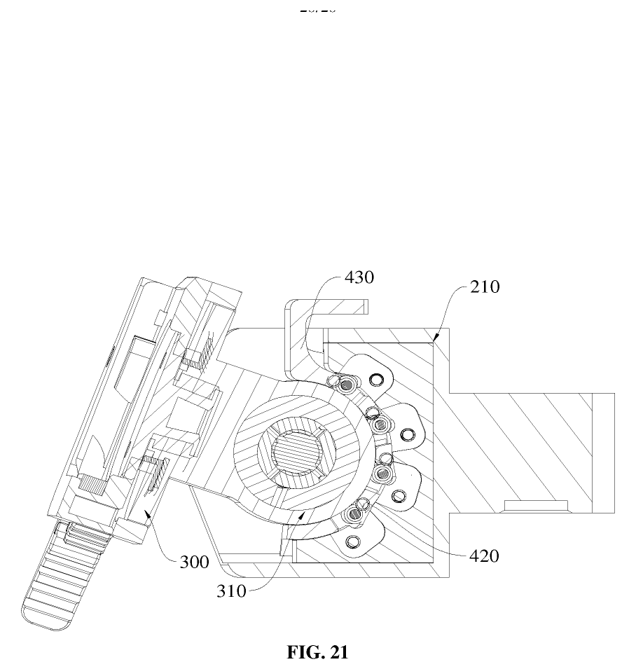

In some aspects, referring to FIGS. 16-21, the connecting head 220 includes a first connecting body 221 and a second connecting body 222 that are detachably connected. The first connecting body 221 is rotatably connected to the inner race 310 about the first rotation axis. The abutment surface 211 is provided on the second connecting body 222. Making the second connecting body 222 as a separate part facilitates mold opening and machining, and the second connecting body 222 can be made of wear-resistant material to increase durability. Both the second connecting body 222 and the retainer 430 are embedded in the first connecting body 221. The actuation part 431 of the retainer 430 is exposed outside the first connecting body 221. The second connecting body 222 is located between the retainer and the first connecting body 221. The first elastic element 450 can be a spring. The side surface of the first connecting body 221 is provided with an arcuate spring arrangement groove 223 and a waist-shaped clamping groove 224 penetrating the side surface. The waist-shaped clamping groove 224 communicates with the spring arrangement groove 223. The first elastic element 450 is installed within the spring arrangement groove 223. The locking assembly 400 further includes a latch pin 460 embedded at the side of the retainer 430 facing the spring arrangement groove 223. The latch pin 460 passes through the waist-shaped clamping groove 224 and extends into the spring arrangement groove 223 to connect to the first elastic element 450.

In some aspects, referring to FIGS. 1-4, the monitor mounting base 300 includes a connecting body 330 and a mounting base body 320. The connecting body 330 is adjustably and rotatably connected to the connecting head 220 about the first rotation axis, allowing adjustment of the height position and tilt angle of the mounting base body 320. The mounting base body 320 is adjustably and rotatably installed on the connecting body 330 about a second rotation axis. The mounting base body 320 is used for mounting the monitor. This allows the connecting body 330 to rotate relative to the connecting head 220 about the first rotation axis, and the mounting base body 320 to rotate relative to the connecting body 330 about the second rotation axis. Thus, the orientation and angle of the mounting base body 320 are further adjusted through multi-stage rotation, enabling adjustment of the angle and orientation of the monitor mounted on the mounting base body 320, which helps enhance the adjustability of the monitor stand for its use.

The rotational connection scheme between the connecting head 220 and the connecting body 330 can be achieved in a damping cooperation form, thereby enabling rotational adjustment and locking after adjustment. Similarly, the rotational adjustment connection scheme between the connecting body 330 and the mounting base body 320 can be implemented in a damping cooperation form. There are also various schemes for providing damping, which are not limited in this disclosure, and any feasible implementation can be adopted.

In some aspects, referring to FIGS. 3-6. The connecting body 330 is rotatably connected to the connecting head 220. The transmission surface 311 is located on the outer profile surface of the connecting body 330, i.e., the connecting body 330 constitutes the inner race 310. The connecting body 330 has a connection hole provided with a second shaft sleeve 280. The connecting head 220 is provided with an expansion sleeve 260. The expansion sleeve 260 has an expansion end 261 and a fixed end 262. The fixed end 262 of the expansion sleeve 260 is connected to the connecting head 220. The expansion end 261 of the expansion sleeve 260 is inserted into the inner cavity of the second shaft sleeve 280. The inner wall of the expansion sleeve 260 has an inclined surface 264 near the expansion end 261. An adjustment column 270 is movably arranged within the expansion sleeve 260. The adjustment column 270 can push against the inclined surface 264 along the axial direction of the expansion sleeve 260, causing the expansion end 261 of the expansion sleeve 260 to expand and abut against the wall of the inner cavity of the second shaft sleeve 280. Together, this design creates a pivot function, and the first rotation axis direction is the axial direction of this pivot. By controlling the displacement of the adjustment column 270, the expansion degree of the expansion end 261 of the expansion sleeve 260 can be adjusted, thereby changing the abutting degree between the expansion end 261 of the expansion sleeve 260 and the second shaft sleeve 280, achieving the effect of adjusting the rotational damping degree between the connecting head 220 and the connecting body 330. In some embodiments, the material of the second shaft sleeve 280 can be a wear-resistant material, such as engineering plastic, to improve wear resistance.

In some aspects, the end of the adjustment column 270 near the expansion end 261 of the expansion sleeve 260 can also be provided with a conical surface 271. The conical surface 271 corresponds to the inclined surface 264, so that the adjustment column 270 can cause the expansion end 261 to expand by pushing against the inclined surface 264.

For example, referring to FIGS. 1-7, the connecting head 220 is configured as a Y-shaped structure with two prongs on one side. The end of the connecting body 330 rotatably connected to the connecting head 220 is inserted between the two prongs of the connecting head 220. Two expansion sleeves 260 are provided. One of the expansion sleeves 260 is integrally formed on the second connecting body 222. The expansion ends 261 of the two expansion sleeves 260 each extend through the portion of the connecting head 220 on one side of the connecting body 330 and into the second shaft sleeve 280. The fixed end 262 of the other expansion sleeve 260 is integrally provided with an annular boss 263. The annular boss 263 is fixed to the first connecting body 221 by fasteners, thereby fixing the two expansion sleeves 260 onto the connecting head 220. The end of the adjustment column 270 with the conical surface 271 is threadedly connected within the expansion sleeve 260 and is close to the expansion end 261, so that the conical surface 271 corresponds to the inclined surface 264, allowing adjustment of the expansion degree of the expansion end 261 by screwing or turning the adjustment column 270. In some embodiments, the adjustment column 270 can be a set screw. The side of the adjustment column 270 near the fixed end 262 of the expansion sleeve 260 can also be provided with a hex socket for adjusting the adjustment column 270 using a hex key.

As monitors come in various types, such as display screens, mobile phones, tablet computers, etc., all of which can be used as monitors, therefore, for the mounting base body, in some embodiments, it can be a mounting plate. The mounting plate is provided with mounting screws for fixing a display screen, such as a high dynamic range display. In other embodiments, it can also include a clamping member, such as existing phone clamps, tablet computer clamps, etc. In other embodiments, it can also be configured in a magnetic coupling mechanism, for example, by adding a magnetic base capable of attaching mobile phones, tablet computers, etc., for the use of mobile phones, tablet computers, etc., as monitors. In summary, any suitable structural component that can be used to fix any type of monitor can serve as the mounting base body.

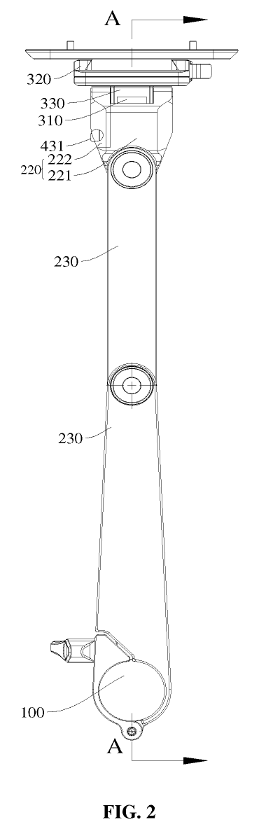

The connecting base 100 is used to fix the monitor stand to an installation foundation. In different embodiments, depending on the installation foundation in the application scenario, the connecting base 100 can have various configurations. For example, in some embodiments, the installation foundation can be a support rod or column on a director's cart, then the connecting base 100 can be a pipe clamp. Exemplarily, referring to FIGS. 1 and 2, the pipe clamp is integrally provided at one end of the support arm 200. The pipe clamp includes a fixed section 110, a movable section 120, and a clamping lever 130. One end of the movable section 120 is hinged to the fixed section 110, and the other end of the movable section 120 serves as a movable end and is connected to the fixed section 110 via the clamping lever 130. The movable section 120 and the fixed section 110 together enclose to form a clamping cavity 140. After passing the support rod or column through the clamping cavity 140, the movable section 120 is locked by adjusting the clamping lever 130, so that the support rod or column is clamped within the clamping cavity 140, completing the clamping installation. In other embodiments, pipe clamps of other structural forms can also be used, and the pipe clamp can also adopt a split structure with the support arm 200, as long as it can be fixed to the support arm 200.

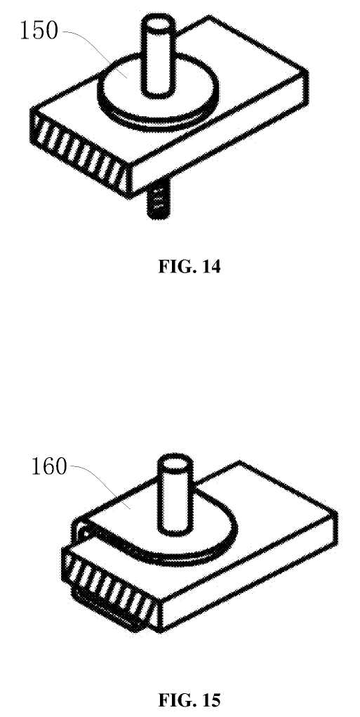

In some aspects, the installation foundation may be a desktop or a panel. In such instances, the connecting base 100 can take the form of a desk clamp. Exemplarily, referring to FIG. 14, if the desktop or panel is equipped with a mounting hole, the connecting base 100 can employ a through-hole mounting desk clamp 150. In some aspects, this desk clamp includes a perforated column and two clamping and locking members mounted on the perforated column. The perforated column is inserted through the hole on the desktop or panel, and then the clamping and locking members are adjusted to securely hold the desktop or panel in place, thereby accomplishing the installation and fixation of the connecting base 100. Referring to FIG. 15, if installation at the edge of a desktop or panel is required, the connecting base 100 can be chosen as an edge-clamp mounting desk clamp 160 with a clamping port. For example, this desk clamp includes a C-shaped clamping member. One side of the C-shaped clamping member forms the clamping port, and set screws are provided on one or both sides of the clamping port on the C-shaped clamping member. During use, the clamping port is fastened onto the edge of the desktop or panel, and the set screws are adjusted to grip the desktop or panel within the clamping port.

By configuring the support arm 200 to connect the connecting base 100 and the monitor mounting base 300, the monitor mounting base 300 can move relative to the connecting base 100, which facilitates the adjustment of the monitor's position. The locking assembly 400 can toggle between the first position and the second position. When the locking assembly 400 is in the first position and the monitor mounting base 300 has a tendency to rotate downward relative to the support arm 200, the locking assembly 400, the transmission surface 311, and the abutment surface 211 work in concert for locking. This prevents the monitor mounting base 300 from rotating downward relative to the support arm 200, without interfering with angle adjustments between the monitor mounting base 300 and the support arm 200 under other circumstances. After adjusting the relative position and angle between the monitor mounting base 300 and the support arm 200 to the target and ensuring that the locking assembly 400 remains in or is switched to the first position, the locking assembly 400 in the first position can lock the monitor mounting base 300 and the support arm 200 when the monitor mounting base 300 has a tendency to rotate downward relative to the support arm 200. This restricts the entire monitor mounting base 300 from undergoing downward-rotating displacement relative to the support arm 200. Therefore, after the monitor is loaded, the monitor mounting base 300 can effectively support the weight of the monitor, and the locking assembly 400 can effectively prevent the monitor mounting base 300 from being driven by the monitor to rotate downward relative to the support arm 200 during use, thereby significantly enhancing the stability of the monitor stand.

Although exemplary embodiments have been described in detail, it should be understood that the invention is not limited to the exact configurations and components shown and described. Parts may be substituted, elements may be reversed, and certain features may be used independently of others, all without departing from the scope of the invention as defined by the claims. Various alternatives, modifications, and equivalents will be apparent to those skilled in the art. For example, the shape, dimensions, or materials of components may be varied, and mechanical linkages may be replaced with equivalent mechanisms that perform the same function. Such alternatives are considered to be within the scope of the invention as defined by the following claims.

The drawings and the associated descriptions are provided to illustrate embodiments of the invention and are not intended to limit the scope of the invention. Relative terms such as “upper,” “lower,” “left,” “right,” “front,” and “rear” are used for convenience only and are not intended to limit the invention to any particular orientation.

What is claimed is:

1. A monitor stand comprising:
a connecting base configured to be fixed to an installation foundation;
a support arm connected to the connecting base;
a monitor mounting base rotatably connected about a first pivot axis to an end of the support arm distal from the connecting base, wherein the monitor mounting base is configured to mount a monitor on the monitor mounting base;
and a locking assembly;
wherein one of the support arm and the monitor mounting base comprises an inner race, and the other one of the support arm and the monitor mounting base comprises an outer race;
wherein the inner race and the outer race are rotatably connected about the first pivot axis;
wherein the inner race is configured with a transmission surface, and the outer race is configured with an abutment surface configured to cooperate with the locking assembly; and
wherein, along a radial direction of the inner race, the locking assembly is adjustably disposed between the abutment surface and the transmission surface, and the locking assembly is configured to abut against the abutment surface to lock the inner race and the outer race, thereby preventing downward rotation of the monitor mounting base.

2. The monitor stand according to claim 1, wherein the locking assembly comprises a transmission member and an elastic member that are connected or abut each other;
wherein the transmission member and the elastic member are both located between the abutment surface and the transmission surface;
wherein the elastic member is configured to provide an elastic force to the transmission member; and
wherein, in response to the monitor mounting base being subjected to a downward force, the transmission surface is configured to trigger the transmission member to press tightly against the abutment surface, thereby locking the inner race and the outer race.

3. The monitor stand according to claim 2, wherein the locking assembly further comprises a retainer disposed between the abutment surface and the transmission surface;
wherein the retainer is rotationally engaged with the inner race, and the retainer is configured to adjust by rotating relative to the inner race and the outer race.
wherein the transmission member is mounted on the retainer;
wherein the retainer is configured with an actuation part exposed beyond at least one of the support arm or the monitor mounting base;
wherein the actuation part is configured for manual adjustment of a position of the retainer to enable the locking assembly to switch between a first position and a second position;
wherein, in response to the retainer being in the first position, the monitor mounting base is configured to rotate upward relative to the support arm, and in response to the monitor mounting base being subjected to a force in a downward direction, the inner race is configured to drive the transmission member to press against the abutment surface, thereby locking the inner race and the outer race; and
wherein, in response to the retainer being in the second position, the locking assembly is configured to unlock the inner race and the outer race, and the monitor mounting base is rotatable both downward and upward about the first pivot axis relative to the support arm.

4. The monitor stand according to claim 3, wherein the retainer has a mounting groove;
wherein the transmission member is movably disposed within the mounting groove; and
wherein the elastic member is fixed to the retainer and extends into the mounting groove to abut or connect to the transmission member.

5. The monitor stand according to claim 4, wherein the monitor stand comprises a plurality of mounting grooves and a plurality of transmission members, the number of the mounting grooves being equal to the number of the transmission members;
wherein the elastic element comprises a number of elastic sheets equal in number to a number of mounting grooves, the elastic sheets and the retainer are integrally formed as a single piece;
wherein the elastic sheets are fixed within the mounting grooves;
wherein each of the mounting grooves comprises a first chamber and a second chamber, and a corresponding elastic sheet of the elastic sheets partitions the first chamber from the second chamber;
wherein the elastic sheet protrudes towards the first chamber to abut the transmission member, and the transmission member is fixed within the first chamber correspondingly via the elastic sheet;
wherein, in response to the retainer being in the first position and the monitor mounting base being rotated upward relative to the support arm, the transmission surface is configured to drive the transmission member to abut the elastic sheet, and the transmission member releases tight pressing against the abutment surface, enabling the monitor mounting base to rotate upward relative to the support arm; and
wherein, in response to the retainer moving to the second position, the retainer is configured to cause the transmission member to move, unlocking the inner race and the outer race, and the monitor mounting base is rotatable both downward and upward about the first pivot axis relative to the support arm.

6. The monitor stand according to claim 3, wherein the retainer comprises a mounting groove;
wherein the transmission member is disposed within the mounting groove; and
wherein the first end of the elastic member is connected to the outer race or the retainer, and the second end is connected to the transmission member.

7. The monitor stand according to claim 6, wherein a plurality of mounting grooves and a plurality of transmission members are provided, arranged in one-to-one correspondence;
wherein the elastic member comprises a plurality of springs;
wherein each of the transmission members is configured with two ends, each end connected to one of the springs; and
wherein an end of each spring away from the transmission member is connected to the outer race or the retainer.

8. The monitor stand according to claim 7, wherein two sides of the retainer are respectively provided with an annular limiting protrusion extending along a circumferential direction of the inner race;
wherein the outer race is located between the two annular limiting protrusions; and
wherein both sides of the outer race are provided with a plurality of accommodation grooves, and each of the plurality of springs is accommodated in a corresponding one of the accommodation grooves.

9. The monitor stand according to claim 3, wherein the abutment surface comprises a plurality of working surfaces corresponding one-to-one with positions of a plurality of transmission members;
wherein, along a circumferential direction of the outer race, the working surfaces are all inclined, forming multiple wedge-shaped spaces on the abutment surface; and
wherein, in response to the locking assembly switching from the first position to the second position, the transmission member is configured to move towards a wide-mouth end of the wedge-shaped space, thereby unlocking the abutment surface and the transmission surface.

10. The monitor stand according to claim 9, wherein the transmission member comprises a plurality of rollers that are arranged at intervals along a circumferential direction of the inner race, corresponding one-to-one with the working surfaces.

11. The monitor stand according to claim 3, wherein the locking assembly further comprises a first elastic element;
wherein the first end of the first elastic element is connected to or abuts the retainer, and the second end of the first elastic element is connected to or abuts the outer race; and
wherein the first elastic element is configured to return the retainer from the second position to the first position in absence of external force.

12. The monitor stand according to claim 3, wherein the monitor mounting base comprises the inner race;
wherein the support arm comprises a main arm and a connecting head that are rotatably connected, the main arm being connected to the connecting base, and the connecting head constituting the outer race;
wherein the connecting head comprises a first connecting body and a second connecting body in connection, and the first connecting body and the second connecting body are both rotatably connected about the first pivot axis to the inner race;
wherein the abutment surface is provided on the first connecting body;
wherein the retainer is mounted between the first connecting body and the second connecting body; and
wherein the actuation part is exposed beyond the first connecting body or the second connecting body.
